(19) United States
(12) Patent Application Publication
(10) Pub. No.: US 2016/0023633 A1
(43) Pub. Date: Jan. 28, 2016

(54) STEERING LOCK DEVICE

(71) Applicant: KABUSHIKI KAISHA TOKAI RIKA DENKI SEISAKUSHO, Aichi (JP)

(72) Inventors: Hiroshi YOSHIDA, Aichi (JP); Takumi TAMEZANE, Aichi (JP); Tomonori KAWACHI, Aichi (JP)

(21) Appl. No.: 14/797,499

(22) Filed: Jul. 13, 2015

(30) Foreign Application Priority Data
Jul. 22, 2014 (JP) 2014-148737

(51) Int. Cl. B60R 25/021

(52) U.S. Cl. CPC B60R 25/021

(57) ABSTRACT

A steering lock device includes a lock body attached to a column post that rotatably supports a steering shaft, a locking bar to lock or unlock a rotation of the steering shaft by a rotating operation of a key cylinder unit housed in the lock body, a lock stopper to allow movement of the locking bar to a lock position or an unlock position, a locking lever to hold the locking bar at the lock position, and a camshaft to convert a rotary motion of the key cylinder unit into a linear motion of the lock stopper. The lock body includes a landing portion with which the lock stopper contacts so as to prevent the lock stopper from contacting with the camshaft in a lock operation that the locking bar is moved to the lock position.

The present application is based on Japanese patent application No. 2014-148737 filed on Jul. 22, 2014, the entire contents of which are incorporated herein by reference.

### BACKGROUND OF THE INVENTION

1. Field of the Invention

The invention relates to a steering lock device for locking the rotation of a vehicle steering shaft.

2. Description of the Related Art

Vehicle steering systems are provided with a steering lock device for locking the rotation of a steering shaft to prevent parked vehicles from motor vehicle theft (see e.g. JP-A-2003-48511).

The steering lock device disclosed in JP-A-2003-48511 is provided with a locking bar for restraining rotation of a steering shaft, a lock stopper fixed to the locking bar, a locking lever holding the lock stopper, and a camshaft integrally rotating with a key rotor into which an ignition key is inserted.

When the ignition key is pulled out while the key rotor is located at a lock position, the locking lever separates away from the lock stopper. The lock stopper, which is then moved together with the locking bar due to a spring force (or resilience) of a compression coil, comes into contact with and lands on a plate cam of the camshaft. The locking bar is engaged with a recessed engaging portion of the steering shaft, thereby restraining the steering shaft from rotating.

### SUMMARY OF THE INVENTION

The steering lock device disclosed in JP-A-2003-48511 is constructed such that the lock stopper comes into contact with the plate cam of the camshaft when the locking bar is moved to the lock position at which the locking bar is engaged with the recessed engaging portion of the steering shaft. Due to the construction, the lock stopper is brought into contact with and is landed on the camshaft by the spring force (or resilience) of the compression coil, and an impact load is applied to the camshaft on which bending moment is thereby likely to be created. Thus, improvement in operational durability of a steering lock system has been desired.

It is an object of the invention to provide a steering lock device with improved operational durability.

(1) According to one embodiment of the invention, a steering lock device comprises:

a lock body attached to a column post that rotatably supports a steering shaft;

a locking bar to lock or unlock a rotation of the steering shaft by a rotating operation of a key cylinder unit housed in the lock body;

a lock stopper to allow movement of the locking bar to a lock position or an unlock position;

a locking lever to hold the locking bar at the lock position; and

a camshaft to convert a rotary motion of the key cylinder unit into a linear motion of the lock stopper,

wherein the lock body comprises a landing portion with which the lock stopper contacts so as to prevent the lock stopper from contacting with the camshaft in a lock operation that the locking bar is moved to the lock position.

In the above embodiment (1) of the invention, the following modifications and changes can be made.

(i) The lock stopper comprises a recessed structure comprising right and left sidewalls and a lower sidewall to connect both ends of the right and left sidewalls such that the camshaft is enclosed by the recessed structure, and wherein a free end face of the right and left sidewalls is formed as a contact portion to contact with the landing portion of the lock body.

(ii) A locking portion formed on the lock stopper is detachably engaged with an end portion of the locking lever.

(iii) The landing portion is formed on a plane perpendicular to a longitudinal direction of the locking bar in an inside wall of the lock body.

(iv) The landing portion comprises two landing portions on both sides of the locking bar.

(v) The locking bar, the lock stopper and the camshaft are assembled along one direction.

(vi) The locking bar is integrated with the lock stopper.

### Effects of the Invention

According to one embodiment of the invention, a steering lock device with improved operational durability can be provided.

### BRIEF DESCRIPTION OF THE DRAWINGS

Next, the present invention will be explained in more detail in conjunction with appended drawings, wherein:

FIG. 1 is an explanatory cutaway perspective view showing a main part of a steering lock device in a preferred embodiment of the present invention in a state that a steering lock unit is located at a LOCK position before extracting a key;

FIGS. 2A and 2B are explanatory diagrams illustrating an assembly procedure of the steering lock unit of the steering lock device in the embodiment, wherein FIG. 2A is a perspective view showing a main part as viewed from one side in an axial direction of a camshaft and FIG. 2B is a perspective view showing the main part as viewed from another side in the axial direction of the camshaft;

FIG. 3 is an explanatory cross sectional view showing the main part of the steering lock device in the embodiment in a state that the steering lock unit is located at an ACC position;

FIG. 4 is an explanatory cutaway perspective view showing the main part of the steering lock device in the embodiment in a state that the steering lock unit is located at the LOCK position after extracting the key; and

FIGS. 5A and 5B are explanatory cross sectional views showing the steering lock device in the embodiment, wherein FIG. 5A shows a state that the steering lock unit is located at the LOCK position before extracting the key and FIG. 5B shows a state that the steering lock unit is located at the LOCK position after extracting the key.

### DETAILED DESCRIPTION OF THE PREFERRED EMBODIMENTS

A preferred embodiment of the invention will be specifically described below in conjunction with the appended drawings.

Configuration of Steering Lock Device

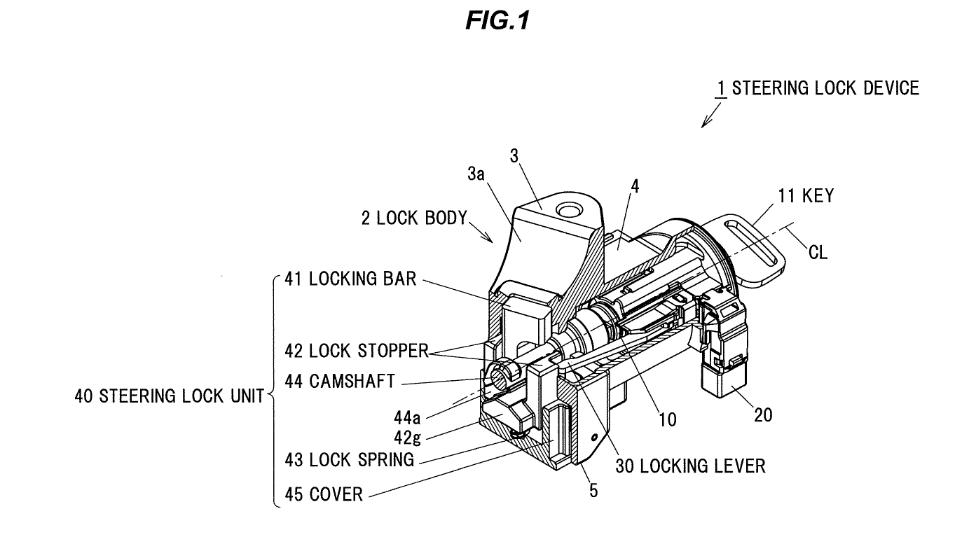

FIG. 1 schematically shows a configuration of a vehicle steering lock device indicated generally by the reference numeral 1. The steering lock device 1 is provided with a lock body 2 formed as one piece of a metal material, e.g., zinc die-cast. The lock body 2 is formed of a block-shaped cylinder which is long in a direction crossing the axial direction of a steering shaft.

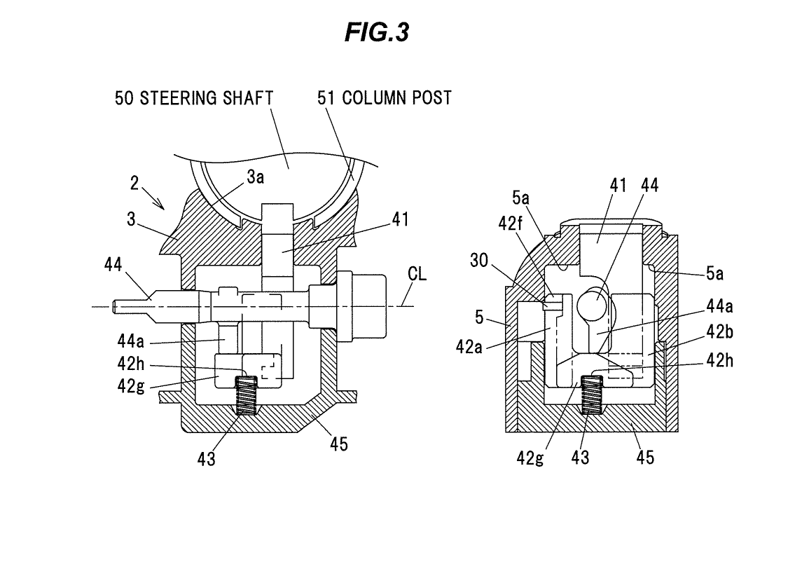

As shown in FIGS. 1 and 3, the lock body 2 is provided with a lock body attachment portion 3 used for attachment to a column post 51 which rotatably houses a steering shaft 50. The lock body attachment portion 3 has an arcuate fitting recess 3a formed at a predetermined inclination angle with respect to a central axis line CL of the lock body 2 and is fixed to the column post 51 by fitting the fitting recess 3a to the outer peripheral surface of the column post 51 and then tightening bolts via a bracket.

A first housing portion 4 having a cylindrical shape for housing a key cylinder unit 10 is provided on one side of the lock body attachment portion 3, as shown in FIG. 1. Another housing portion for attaching an engine-driving ignition switch unit is provided on another side of the lock body attachment portion 3.

The key cylinder unit 10 is provided with a key cylinder capable of mechanical authentication of a mechanical key 11 (hereinafter, referred to as “key 11”). The key cylinder is formed to be rotatably operable by the key 11 inserted into a key insertion hole in, e.g., a clockwise direction from LOCK position to three lock release (unlock) positions —an ACC (accessory) position, an ON position and a START position—when viewing the key insertion hole from the front side.

The ignition switch unit (not shown) has a mechanism to perform a switching operation in conjunction with a rotating operation of the key cylinder unit 10 by the key 11 and switches the contact point connection status between “LOCK”, “ACC”, “ON” and “START” so as to correspond to the LOCK position, the ACC position, the ON position and the START position of the key cylinder unit. The status of various in-vehicle devices and engine is switched based on the connection status of the ignition switch unit.

A key detection switch 20 is attached to a side surface of the first housing portion 4 of the lock body 2. The key detection switch 20 is a switch for detecting presence of the key 11 in the key insertion hole of the key cylinder and is used as, e.g., a switch for preventing a key from being left in the key cylinder by detecting the extraction state of the key 11 from the key cylinder.

Configuration of Steering Lock Unit

Inside the lock body attachment portion 3, a second housing portion 5 having a square cylindrical shape is provided to house a steering lock unit 40 which restricts or releases rotation of the steering shaft 50, as shown in FIG. 1.

As shown in FIGS. 1 to 3, the steering lock unit 40 is provided with a locking bar 41 for locking or unlocking rotation of the steering shaft 50 based on rotating operation of the key cylinder unit 10 and a lock stopper 42 which moves the locking bar 41 to a lock position or an unlock position.

As shown in FIGS. 1 to 3, the steering lock unit 40 is further provided with a lock spring 43 for pressing the locking bar 41 toward the steering shaft 50, a camshaft 44 converting rotary motion of the key cylinder unit 10 produced by key operation into linear motion of the lock stopper 42, and a bottomed-cylindrical cover 45 for holding such internal components.

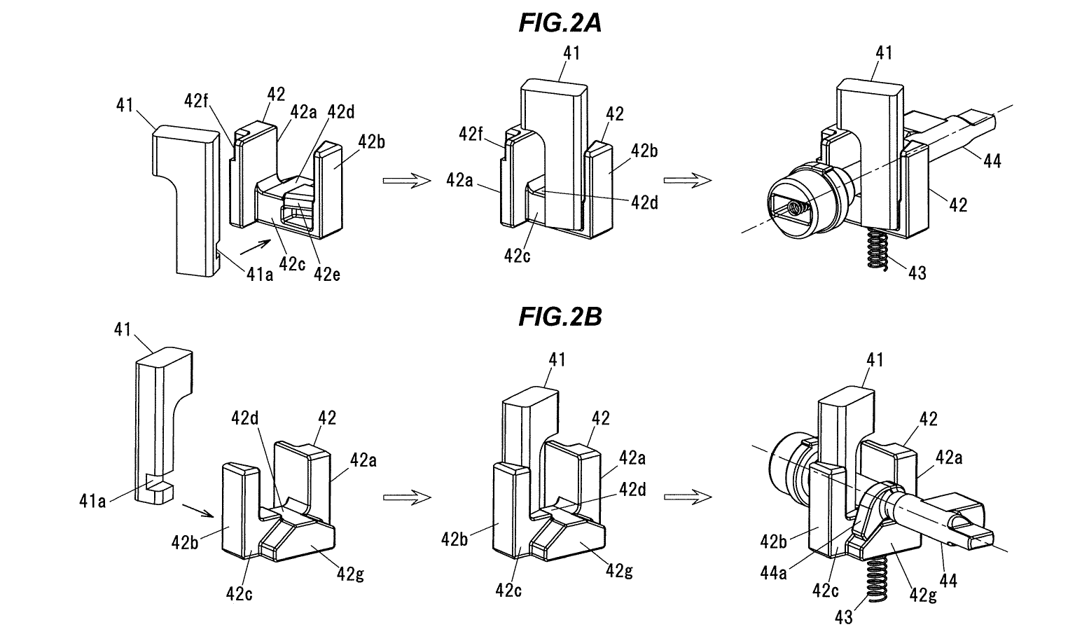

The locking bar 41 is a long-bar-shaped steering lock member formed of a highly rigid metal material and a locking groove 41a for locking the lock stopper 42 is formed at an end portion of the lock member, as shown in FIGS. 2A and 2B. The locking bar 41 is maintained to a locked state or an unlocked state by a locking lever 30 which is rotatably supported inside the first housing portion 4.

The locking lever 30 is formed of a rolled steel plate having a long shape and is arranged along the key cylinder unit 10. The locking lever 30 is constantly pressed toward the steering lock unit 40 by a spring member (not shown) attached inside the first housing portion 4.

The lock stopper 42 has left and right sidewalls 42a and 42b and a lower sidewall 42c coupling end portions of the sidewalls 42a and 42b, as shown in FIGS. 2A and 2B. A recessed portion 42d defined by the sidewalls 42a to 42c is arranged to straddle a shaft portion of the camshaft 44. A locking protrusion 42e to be locked in the locking groove 41a of the locking bar 41 is formed to protrude from a surface of the right sidewall 42b facing the left sidewall.

As shown in FIGS. 2A and 2B, a locking recess 42f for removably fitting an end portion of the locking lever 30 is formed on the outer surface of the left sidewall 42a of the lock stopper 42. A force (or resilience) is applied to the locking recess 42f by the spring member of the locking lever 30.

When the steering lock unit 40 is located at the LOCK position before extracting the key or the ACC position as shown in FIGS. 1, 3 and 5A, the locking lever 30 is engaged with the locking recess 42f of the lock stopper 42 and holds the locking bar 41 at the unlock position.

Even when the steering lock unit 40 is switched from the ACC position to the ON or START position, the locking lever 30 is still engaged with the locking recess 42f of the lock stopper 42 and still holds the locking bar 41 at the unlock position.

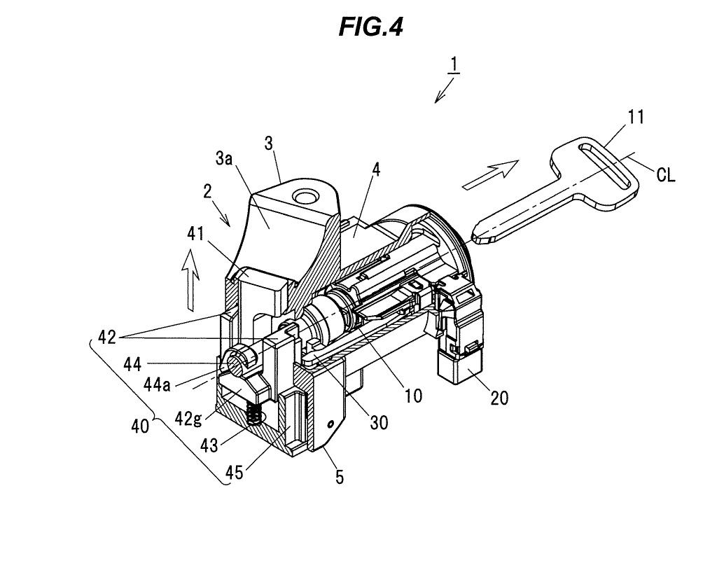

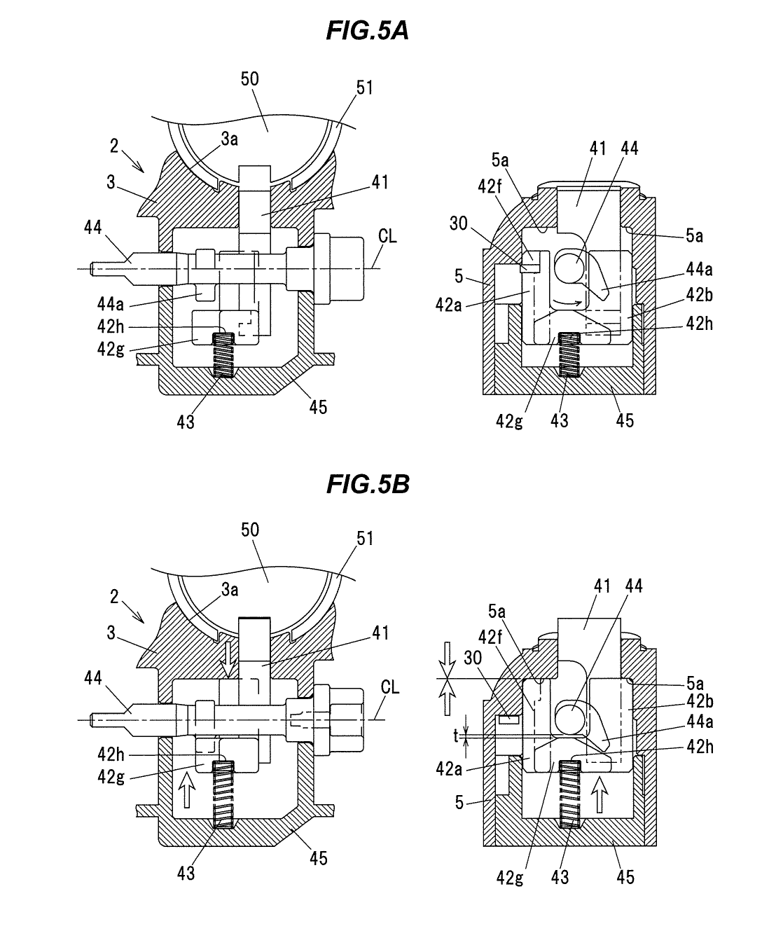

On the other hand, when the steering lock unit 40 is located at the LOCK position after extracting the key as shown in FIGS. 4 and 5B, the locking lever 30 is disengaged from the locking recess 42f of the lock stopper 42. The locking bar 41 is moved to and held at the lock position.

A cam follower 42g is raised from the lower sidewall 42c of the lock stopper 42 as shown in FIGS. 1 to 3 to advance and retract the locking bar 41 via the camshaft 44 along with the rotating operation of the key cylinder. Meanwhile, a spring support recess 42h for supporting an end portion of the lock spring 43 is formed on an outer bottom surface of the lower sidewall 42c of the lock stopper 42.

On the shaft portion of the camshaft 44, a cam portion 44a for moving the lock stopper 42 back and forward via the lock spring 43 along with the rotating operation of the key cylinder is formed in a protruding manner, as shown in FIGS. 1 to 3. The camshaft 44 is arranged on the same axis as the key cylinder unit 10 and is attached to a front end portion of the key cylinder.

The steering lock unit 40 configured as described above is configured that the locking bar 41, the lock stopper 42, the lock spring 43 and the camshaft 44 can be attached to the cover 45 along one direction as shown in FIGS. 1 to 2B, and all components of the steering lock unit 40 can be collectively assembled to the second housing portion 5 of the lock body 2 along one direction.

For assembly of the steering lock unit 40, firstly, the locking groove 41a of the locking bar 41 is engaged with the locking protrusion 42e of the lock stopper 42, as shown in FIGS. 2A and 2B. Next, the camshaft 44 is placed within the locking recess 42f of the lock stopper 42. Then, one end of the lock spring 43 is attached to the outer bottom surface of the lower sidewall 42c of the lock stopper 42.

Although the locking bar 41 and the lock stopper 42 are separate components in the illustrated example, it is not limited thereto. For example, the locking bar 41 and the lock stopper 42 may be formed integrally.

The steering lock unit 40 having such a simple assembly structure is easy to assemble, thereby allowing for automation thereof using automatic robots. It is thereby possible to reduce assembly man-hours and the manufacturing cost, etc., of the entire steering lock device 1.

In the meantime, it is preferable that the lock stopper 42 do not come into contact with and land on the camshaft 44 so that an impact load generated by a spring force of the lock spring 43 is not applied to the camshaft 44 during a lock operation of moving the locking bar 41 from the unlock position to the lock position. The steering lock unit 40 in the illustrated example is configured that the lock stopper 42 lands on a portion of the lock body 2 at the time of the lock operation.

As shown in FIGS. 2A to 3 and 5B, a lock stopper-facing surface 5a of the second housing portion 5 of the lock body 2 is configured to serve as a landing portion (or receiving portion or contact portion) such that free end faces of the left and right sidewalls 42a and 42b of the lock stopper 42 come into contact with and land on the lock stopper-facing surface 5a. Meanwhile, the free end faces of the left and right sidewalls 42a and 42b of the lock stopper 42 are configured to serve as contact portions to be in contact with the landing portion formed on the lock body 2.

As shown in FIG. 5B, the free end faces of the left and right sidewalls 42a and 42b of the lock stopper 42 contact with the lock stopper-facing surface 5a of the lock body 2, but the camshaft 44 does not contact with the cam follower 42g of the lock stopper 42. Thus, a predetermined gap t is made between the camshaft 44 and the cam follower 42g even when the lock stopper 42 contacts with the lock stopper-facing surface or the landing portion 5a at the lock position.

Since the portion on which the lock stopper 42 lands during the lock operation of moving the locking bar 41 from the unlock position to the lock position is not formed on the camshaft 44 but formed on the lock body 2, it is possible to provide a structure in which an impact load during the lock operation is not applied to the camshaft 44 and thereby to improve operational durability of the steering lock unit 40.

FIG. 3 shows the state in which the steering lock unit 40 is located at the ACC position. The locking lever 30 is engaged with the locking recess 42f of the lock stopper 42 and holds the locking bar 41 at the unlock position.

As shown in FIG. 3, the cam portion 44a of the camshaft 44 rests still on a cam surface of the cam follower 42g of the lock stopper 42 against a resilient force of the lock spring 43. The locking bar 41 is retracted into the lock body attachment portion 3 of the lock body 2 and the rotation of the steering shaft 50 is thus unlocked.

FIG. 5A shows the state in which the steering lock unit 40 is located at the LOCK position before extracting the key. FIG. 5B shows the state in which the steering lock unit 40 is located at the LOCK position after extracting the key.

When the key cylinder unit 10 is rotated from the ACC position to the LOCK position, the cam portion 44a of the camshaft 44 rotates in a direction separating from the cam surface of the cam follower 42g of the lock stopper 42 against the resilient force of the lock spring 43, as shown in FIG. 5A. The locking lever 30 is still engaged with the locking recess 42f of the lock stopper 42. Therefore, the lock stopper 42 is restricted from moving and the locking bar 41 is thus still held at the unlock position.

In the state that the key cylinder unit 10 is located at the LOCK position after extracting the key, the locking lever 30 rotates in a direction separating from the locking recess 42f of the lock stopper 42. Along with the rotation of the locking lever 30, the lock stopper 42 is moved toward the camshaft 44 by the resilient force of the lock spring 43.

The lock stopper 42 comes into contact with and lands on the lock stopper-facing surface 5a of the lock body 2. At this time, the camshaft 44 is not in contact with the cam follower 42g of the lock stopper 42. Along with the movement of the of the lock stopper 42, the locking bar 41 comes out from the lock body attachment portion 3 of the lock body 2 toward the column post, thereby locking the rotation of the steering shaft 50.

In the process of rotation of the key cylinder unit 10 from the LOCK position through the ACC position to the ON or START position, the cam portion 44a of the camshaft 44 rotates along the cam surface of the cam follower 42g of the lock stopper 42 against the resilient force of the lock spring 43.

Along with the rotation of the cam portion 44a of the camshaft 44, the lock stopper 42 moves in a direction separating from the camshaft 44 against the resilient force of the lock spring 43. The locking bar 41 is retracted into the lock body attachment portion 3 of the lock body 2 along with the movement of the lock stopper 42 and the rotation of the steering shaft 50 is thereby unlocked.

### Effects of the Embodiment

The steering lock device 1 configured as described above exerts the following effects in addition to the above-mentioned effects.

(1) Since an impact load generated by the lock spring 43 is not applied to the camshaft 44 and bending moment is not created on the camshaft 44 during the lock operation of moving the locking bar 41 from the unlock position to the lock position, likelihood of damage on the camshaft 44 is reduced and it is thus possible to improve operational durability of the steering lock device 1. In addition, high reliability is obtained.

(2) The structure in which the lock stopper 42 comes into contact with and lands on the lock body 2 reduces component tolerances which affect a protruding margin of the locking bar 41 to protrude from the lock body attachment portion 3 of the lock body 2 toward the column post 51. Therefore, the protruding margin of the locking bar 41 is stabilized and locking performance is improved.

Although the steering lock device 1 of the invention have been described based on the embodiment and examples, the invention is not to be limited to the embodiment and examples as obvious from the above description, and can be implemented in various forms without departing from the gist thereof.

It should be noted that all combinations of the features described in the embodiment and examples are not necessary to solve the problem of the invention.

What is claimed is:

1. A steering lock device, comprising:
a lock body attached to a column post that rotatably supports a steering shaft;
a locking bar to lock or unlock a rotation of the steering shaft by a rotating operation of a key cylinder unit housed in the lock body;
a lock stopper to allow movement of the locking bar to a lock position or an unlock position;
a locking lever to hold the locking bar at the lock position; and
a camshaft to convert a rotary motion of the key cylinder unit into a linear motion of the lock stopper,
wherein the lock body comprises a landing portion with which the lock stopper contacts so as to prevent the lock stopper from contacting with the camshaft in a lock operation that the locking bar is moved to the lock position.

2. The steering lock device according to claim 1, wherein the lock stopper comprises a recessed structure comprising right and left sidewalls and a lower sidewall to connect both ends of the right and left sidewalls such that the camshaft is enclosed by the recessed structure, and
wherein a free end face of the right and left sidewalls is formed as a contact portion to contact with the landing portion of the lock body.

3. The steering lock device according to claim 1, wherein a locking portion formed on the lock stopper is detachably engaged with an end portion of the locking lever.

4. The steering lock device according to claim 1, wherein the landing portion is formed on a plane perpendicular to a longitudinal direction of the locking bar in an inside wall of the lock body.

5. The steering lock device according to claim 4, wherein the landing portion comprises two landing portions on both sides of the locking bar.

6. The steering lock device according to claim 1, wherein the locking bar, the lock stopper and the camshaft are assembled along one direction.

7. The steering lock device according to claim 1, wherein the locking bar is integrated with the lock stopper.
